(19) United States
(12) Patent Application Publication
(10) Pub. No.: US 2023/0415613 A1
(43) Pub. Date: Dec. 28, 2023

(54) METHOD OF HEATING POWERTRAIN, COMPUTER PROGRAM, COMPUTER-READABLE MEDIUM, CONTROL ARRANGEMENT, POWERTRAIN, AND VEHICLE

(71) Applicant: Scania CV AB, Södertälje (SE)

(72) Inventors: Oscar HÄLLMAN, Södertälje (SE); Christer ROOS, Rönninge (SE); Ola HALL, Stockholm (SE)

(73) Assignee: Scania CV AB, Södertälje (SE)

(21) Appl. No.: 18/037,016

(22) PCT Filed: Nov. 4, 2021
(86) PCT No.: PCT/SE2021/051101

§ 371 Date: May 15, 2023

(30) Foreign Application Priority Data
Nov. 24, 2020 (SE) 2051368-5

(51) Int. Cl. B60L 58/27; B60L 15/20; B60L 50/50; B60L 58/25; B60L 7/00; H02P 29/62; B60L 1/02

(52) U.S. Cl. CPC B60L 58/27; B60L 15/2054; B60L 15/2045; B60L 50/50; B60L 58/25; B60L 7/00; H02P 29/62; B60L 1/02; B60L 2240/425; B60L 2240/485; B60L 2240/545; B60L 2260/22

(57) ABSTRACT

A method of heating a powertrain of a vehicle is disclosed, wherein the powertrain comprises an electric machine configured to provide motive power to the vehicle. The method comprises the step of passing an electric current through the electric machine to rotate a rotor of the electric machine while ensuring stand still of the vehicle. The present disclosure further relates to a computer program, a computer-readable medium, a control arrangement, a powertrain for a vehicle, and a vehicle comprising a powertrain.

### CROSS-REFERENCE TO RELATED APPLICATIONS

This application is a National Stage Patent Application (filed under 35 § U.S.C. 371) of PCT/SE2021/051101, filed Nov. 4, 2021, of the same title, which, in turn claims priority to Swedish Patent Application No. 2051368-5 filed Nov. 24, 2020, of the same title; the contents of each of which are hereby incorporated by reference.

### FIELD OF THE INVENTION

The present disclosure relates to a method of heating a powertrain of a vehicle, wherein the powertrain comprises an electric machine configured to provide motive power to the vehicle. The present disclosure further relates to a computer program, a computer-readable medium, a control arrangement, a powertrain for a vehicle, and a vehicle comprising a powertrain.

### BACKGROUND OF THE INVENTION

The use of electric drive for vehicles provides many advantages, especially regarding local emissions. Such vehicles comprise one or more electric machines configured to provide motive power to the vehicle. These types of vehicles can be divided into the category's pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

An electric machine is a machine that converts electrical energy into mechanical energy and vice versa. Most electric machines comprise magnets and wire windings, wherein the electric machine operate through the interaction between the magnetic field of the magnets and electric current in the wire windings to generate power in the form of torque and rotation of a rotor of the electric machine. The rotor is usually surrounded by a stator. Some electric machines comprise magnets in the rotor and wire windings in the stator and some other electric machines comprise wire windings in the rotor and magnets in the stator.

An electric powertrain usually comprises a transmission configured to transmit power between the electric machine and one or more wheels of the vehicle. The electricity is usually stored in a rechargeable battery of the vehicle and some different types of batteries are used, such as lithium-ion batteries, lithium polymer batteries, and nickel-metal hydride batteries. Most types of batteries, such as those listed above, are temperature sensitive meaning that they have a temperature range in which they are most efficient. That is, most types of batteries, such as those listed above, have reduced efficiency when the temperature of the battery is low. This means that the energy storing capability, the charging efficiency and the discharge efficiency of the battery may become reduced at low temperatures. Moreover, too high temperatures and too low temperatures may damage and/or reduce the lifetime of the battery.

Cold starts, i.e. starts at low temperatures, are problematic also for electric powertrains. That is, if the powertrain and the components thereof are cold, they provide higher power losses. The higher power losses cause a higher energy consumption which reduces the available operational range of the vehicle. Moreover, operation with a cold powertrain may cause wear of components of the powertrain and may thereby reduce the lifetime of the components of the powertrain.

Moreover, generally, on today's consumer market, it is an advantage if vehicles and their associated components and systems have conditions and/or characteristics suitable for being manufactured and assembled in a cost-efficient manner.

### SUMMARY OF THE INVENTION

It is an object of the present invention to overcome, or at least alleviate, at least some of the above-mentioned problems and drawbacks.

According to a first aspect of the invention, the object is achieved by a method of heating a powertrain of a vehicle, wherein the powertrain comprises an electric machine configured to provide motive power to the vehicle. The method comprises the step of:
passing an electric current through the electric machine to rotate a rotor (6) of the electric machine while ensuring stand still of the vehicle.

Since the method comprises the step of passing an electric current through the electric machine while ensuring stand still of the vehicle, a simple and efficient method is provided capable of heating the powertrain. Moreover, since the electric machine is used for heating the powertrain, the method circumvents, or at least reduces, the need for separate heating arrangements or systems for heating the powertrain.

Development of vehicles has led to an increasing number of components and subsystems in vehicles each adding costs, weight, and complexity to vehicles. However, as indicated above, since the method comprises the step of passing an electric current through the electric machine while ensuring stand still of the vehicle, a method is provided capable of heating the powertrain using existing components of the powertrain and thereby heating the powertrain in an energy-efficient and less complex manner circumventing, or at least reducing, the need for costly and heavy arrangements and systems for heating the powertrain.

Moreover, since the powertrain is heated by the step of passing the electric current through the electric machine, the method provides conditions for reduced power losses in a subsequent start-up of the vehicle and thereby also conditions for an increased available operational range of the vehicle in a simple and cost-efficient manner. Moreover, since the powertrain is heated by the step of passing the electric current through the electric machine, the method provides conditions for a reduced wear of components of the powertrain in a simple and cost-efficient manner.

Accordingly, a method is provided overcoming, or at least alleviating, at least some of the above-mentioned problems and drawbacks. As a result, the above-mentioned object is achieved.

According to the invention, a method is provided capable of heating the powertrain in a simple and energy-efficient manner circumventing, or at least reducing, the need for separate heating arrangements or systems for heating the powertrain. Moreover, since the rotor of the electric machine is rotated by the passing of the electric current, conditions are provided for an increased distribution of the heat generated in the electric machine. Stand still of the vehicle can be ensured by disconnecting the rotor from one or more wheels of the vehicle.

Optionally, the powertrain comprises a transmission configured to transmit power between the electric machine and one or more wheels of the vehicle, and wherein the method comprises the step of:
controlling the powertrain to a state in which at least a portion of the transmission is disconnected from the one or more wheels, and
rotating the portion of the transmission using the rotor.

Thereby, a method is provided capable of heating the transmission of the powertrain in a simple and energy-efficient manner circumventing, or at least reducing, the need for separate heating arrangements or systems for heating the powertrain. Moreover, since the method comprises the step of rotating the portion of the transmission using the rotor of the electric machine, the method provides conditions for distributing the heat generated by the passing of the electric current through the electric machine to components and subsystems of the powertrain in a more efficient manner. In addition, the heat generating capability can be increased because frictional losses in the portion of the transmission may generate heat during rotation thereof.

Optionally, the method may further comprise the separate step of:
passing an electric current through the electric machine in a manner ensuring stand still of the rotor.

Thereby, a method is provided capable of heating the powertrain in a simple manner circumventing, or at least reducing, the need for separate heating arrangements or systems for heating the powertrain. Moreover, conditions are provided for heating the powertrain by heating the electric machine while ensuring stand still of the rotor and then distribute the heat in a more efficient manner by passing the electric current through the electric machine to rotate the rotor. In this manner, the method provides conditions for reduced wear of components of the powertrain and an increased available operational range of a vehicle.

Optionally, the step of passing the electric current through the electric machine in a manner ensuring stand still of the rotor is performed prior to the step of passing the electric current through the electric machine to rotate the rotor.

Thereby, the method provides conditions for reduced wear of components of the powertrain because the passing of the electric current through the electric machine during stand still of the rotor may heat the powertrain before the rotation of the rotor is initiated. As a further result thereof, the rotor may be rotated in a manner providing lower power losses when the electric current is passed through the electric machine to rotate the rotor.

According to further embodiments, these steps are performed in the reverse order. Thus, according to such embodiments, the step of passing the electric current through the electric machine to rotate the rotor is performed prior to the step of passing the electric current through the electric machine in a manner ensuring stand still of the rotor.

Optionally, the method comprises the step of:
switching back and forth between a first heating mode in which the electric current is passed through the electric machine in a manner ensuring stand still of the rotor and a second heating mode in which the electric current is passed through the electric machine to rotate the rotor.

Thereby, a method is provided capable of switching between a first mode in which the electric machine is heated in a simple and energy efficient manner and a second mode in which the electric machine can be heated in a simple and energy efficient manner while distributing the generated heat in an improved manner.

Optionally, the method comprises the steps of:
inputting current temperature data representative of a current ambient temperature and/or a current temperature of a portion of the powertrain, and
controlling a duration of the passing of the electric current through the electric machine based on the inputted current temperature data.

As a result, conditions are provided for heating the powertrain to a determined temperature range in an efficient manner. Moreover, conditions are provided for avoiding excessive heating of the powertrain and too high temperatures of the powertrain. Thus, a more energy efficient method is provided capable of heating the powertrain in an adaptive manner based on current temperature conditions.

Optionally, the method comprises the steps of:
estimating a time at which the vehicle is expected to be operated, and
initiating the step of passing the electric current through the electric machine a predetermined time before the estimated time.

Thereby, a method is provided having conditions for reaching a determined temperature level of the powertrain with higher certainty before the vehicle is expected to be operated. Moreover, a method is provided having conditions for avoiding excessive heating of the powertrain. Accordingly, an adaptive and energy efficient method is provided having conditions for reducing wear of components of the powertrain and an increasing available operational range of the vehicle when the vehicle is expected to be operated.

Optionally, the method comprises the steps of:
inputting current temperature data representative of a current ambient temperature and/or a current temperature of a portion of the powertrain, and
setting a length of the predetermined time based on the current temperature data.

Thereby, a determined temperature level of the powertrain can be reached with even higher certainty before operation of the vehicle is initiated at various temperature conditions. Accordingly, an energy efficient method is provided capable of initiating heating of the powertrain in an adaptive manner based on current temperature conditions which provides improved conditions reducing wear of components of the powertrain and increasing the available operational range of the vehicle when operation of the vehicle is initiated at various temperature conditions.

Optionally, the powertrain comprises a lubricant circuit comprising a lubricant pump configured to pump lubricant through the lubricant circuit to lubricate portions of the powertrain, and wherein the method comprises the step of:
activating the lubricant pump.

Thereby, the heat generated by the passing of the electric current through the electric machine is distributed to other portions of the powertrain in a simple and efficient manner. Moreover, a method is provided capable of distributing the heat using already existing components of the powertrain in a cost-efficient and non-complex manner.

Optionally, the powertrain comprises a propulsion battery, and wherein the method comprises the step of:
heating the propulsion battery using heat generated by the passing of the electric current through the electric machine.

Thereby, a method is provided capable of heating the propulsion battery using existing components of the powertrain and thereby heating the propulsion battery in simple and efficient manner. Moreover, since the propulsion battery is heated, the method provides conditions for an improved efficiency of the propulsion battery and thereby conditions for a further improved available operational range of the vehicle.

Optionally, the powertrain comprises a battery coolant circuit comprising a coolant pump configured to pump coolant through the battery coolant circuit to regulate the temperature of the propulsion battery, and wherein the step of heating the propulsion battery comprises the step of:
activating the coolant pump of the battery coolant circuit.

Thereby, a method is provided capable of transferring heat from the electric machine to the propulsion battery in a simple, energy efficient, and cost-efficient manner. Moreover, a method is provided having conditions for utilizing already existing components of the vehicle for transferring heat from the electric machine to the propulsion battery.

Optionally, the vehicle comprises an occupant compartment, and wherein the method comprises the step of:
heating the occupant compartment using heat generated by the passing of the electric current through the electric machine.

Thereby, a method is provided capable of heating the occupant compartment using existing components of the powertrain and thereby heating the occupant compartment in an energy-efficient and simple manner circumventing, or at least reducing, the need for separate heating arrangements or systems for heating the occupant compartment.

Optionally, the powertrain comprises a heat exchanger configured to heat the occupant compartment using heat from the powertrain, and wherein the step of heating the occupant compartment comprises the step of:
circulating coolant through the heat exchanger.

Thereby, a method is provided capable of transferring heat from the electric machine to the occupant compartment in a simple, energy efficient, and cost-efficient manner. Moreover, a method is provided having conditions for utilizing already existing components of the vehicle for transferring heat from the electric machine to the occupant compartment in an efficient manner.

Optionally, the vehicle comprises a propulsion battery and a charging module connectable to an external power source to charge the propulsion battery using electricity from the external power source, and wherein the step/steps of passing the electric current through the electric machine is/are performed when the charging module is connected to the external power source.

Thereby, electrical energy from the external power source can be used to heat the powertrain instead of electrical energy from the propulsion battery. In this manner, an increased available operational range of the vehicle can be ensured when operation of the vehicle is initiated in a simple, energy efficient, and cost-efficient manner.

According to a second aspect of the invention, the object is achieved by a computer program comprising instructions which, when the program is executed by a computer, cause the computer to carry out the method according to some embodiments of the present disclosure. Since the computer program comprises instructions which, when the program is executed by a computer, cause the computer to carry out the method according to some embodiments, a computer program is provided which provides conditions for overcoming, or at least alleviating, at least some of the above-mentioned drawbacks. As a result, the above-mentioned object is achieved.

According to a third aspect of the invention, the object is achieved by a computer-readable medium comprising instructions which, when executed by a computer, cause the computer to carry out the method according to some embodiments of the present disclosure. Since the computer-readable medium comprises instructions which, when the program is executed by a computer, cause the computer to carry out the method according to some embodiments, a computer-readable medium is provided which provides conditions for overcoming, or at least alleviating, at least some of the above-mentioned drawbacks. As a result, the above-mentioned object is achieved.

According to a fourth aspect of the invention, the object is achieved by a control arrangement for a powertrain of a vehicle, wherein the powertrain comprises an electric machine configured to provide motive power to the vehicle. The control arrangement is configured to pass an electric current through the electric machine to rotate a rotor of the electric machine (5) while ensuring stand still of the vehicle.

Thereby, a control arrangement is provided capable of heating the powertrain in an energy-efficient and simple manner circumventing, or at least reducing, the need for costly and complex arrangements and systems for heating the powertrain. Accordingly, a control arrangement is provided having conditions for using already existing components of the powertrain for heating the powertrain.

Moreover, since the powertrain is heated by the passing of the electric current through the electric machine, the control arrangement provides conditions for reduced power losses in a subsequent start-up of the vehicle and thereby also conditions for an increased available operational range of the vehicle in a simple and cost-efficient manner. Moreover, since the powertrain is heated by the passing of the electric current through the electric machine, the control arrangement provides conditions for a reduced wear of components of the powertrain in a simple and cost-efficient manner.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement may be configured to perform any one of the method steps described in the present disclosure.

According to a fifth aspect of the invention, the object is achieved by a powertrain for a vehicle. The powertrain comprises an electric machine configured to provide motive power to the vehicle and a control arrangement according to some embodiments of the present disclosure.

Since the powertrain comprises a control arrangement according to some embodiments, a powertrain is provided which can be heated an energy-efficient and simple manner circumventing, or at least reducing, the need for costly and complex arrangements and systems for heating the powertrain.

Moreover, since the powertrain is heated by the passing of the electric current through the electric machine, the powertrain provides conditions for reduced power losses in a subsequent start-up of the powertrain and thereby also conditions for an increased available operational range of a vehicle comprising the powertrain in a simple and cost-efficient manner. Moreover, since the powertrain is heated by the passing of the electric current through the electric machine, conditions are provided for a reduced wear of components of the powertrain.

Accordingly, a powertrain is provided overcoming, or at least alleviating, at least some of the above-mentioned problems and drawbacks. As a result, the above-mentioned object is achieved.

According to a sixth aspect of the invention, the object is achieved by a vehicle comprising a powertrain according to some embodiments of the present disclosure.

Since the vehicle comprises a powertrain according to some embodiments, a vehicle is provided comprising a powertrain which can be heated an energy-efficient and simple manner circumventing, or at least reducing, the need for costly and complex arrangements and systems for heating the powertrain. Accordingly, a vehicle is provided having conditions for using already existing components of the powertrain for heating the powertrain.

Moreover, since the powertrain is heated by the passing of the electric current through the electric machine, the vehicle provides conditions for reduced power losses in a subsequent start-up of the powertrain and thereby also conditions for an increased available operational range of the vehicle in a simple and cost-efficient manner. Moreover, since the powertrain of the vehicle is heated by the passing of the electric current through the electric machine, conditions are provided for a reduced wear of components of the powertrain.

Accordingly, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a vehicle according to some embodiments,

FIG. 2 schematically illustrates a powertrain of the vehicle illustrated in FIG. 1,

FIG. 3 illustrates a method of heating a powertrain of a vehicle, and

FIG. 4 illustrates computer-readable medium according to some embodiments.

### DETAILED DESCRIPTION OF THE INVENTION

Aspects of the present invention will now be described more fully. Like numbers refer to like elements throughout. Well-known functions or constructions will not necessarily be described in detail for brevity and/or clarity.

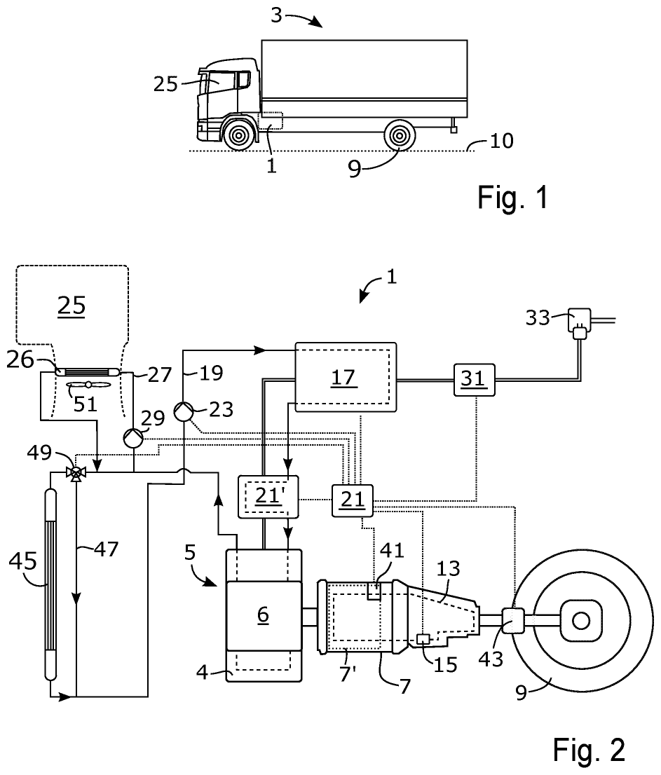

FIG. 1 illustrates a vehicle 3 according to some embodiments. According to the illustrated embodiments, the vehicle 3 is a truck, i.e. a heavy vehicle. According to further embodiments, the vehicle 3, as referred to herein, may be another type of manned or unmanned vehicle for land based propulsion such as a lorry, a bus, a construction vehicle, a tractor, a car, or the like.

The vehicle 3 comprises a powertrain 1. The powertrain 1 is configured to provide motive power to the vehicle 3 via wheels 9 of the vehicle 3. The powertrain 1 is an at least partially electric powertrain, as is further explained herein. In FIG. 1, the vehicle 3 is illustrated as positioned onto a surface 10.

FIG. 2 schematically illustrates the powertrain 1 of the vehicle 3 illustrated in FIG. 1. Below, simultaneous reference is made to FIG. 1 and FIG. 2, if not indicated otherwise. The powertrain 1 comprises an electric machine 5. The electric machine 5 is configured to provide motive power to the vehicle 3 via wheels 9 of the vehicle 3. The electric machine 5 may also be referred to as an electric propulsion motor, an electric motor, or the like. According to the illustrated embodiments, the powertrain 1 is a pure electric powertrain and comprise no internal combustion engine. According to further embodiments, the powertrain 1, as referred to herein, may be a so called hybrid electric powertrain comprising an internal combustion engine in addition to the electric machine 5 for providing motive power to the vehicle 3. In FIG. 2, the powertrain 1 is illustrated as comprising one electric machine 5. However, the powertrain 1 may comprise more than one electric machine 5. According to the illustrated embodiments, the powertrain 1 comprises a transmission 7. The transmission 7 is configured to transmit power between the electric machine 5 and one or more wheels 9 of the vehicle 3.

The powertrain 1 comprises a propulsion battery 17. The propulsion battery 17 is configured to supply electricity to the electric machine 5 by an amount controlled by a power module 21′. The power module 21′ may comprise power electronics. The propulsion battery 17 may comprise a number of battery cells, such as lithium-ion battery cells, lithium polymer batteries cells, or nickel-metal hydride battery cells. The electric machine 5 comprises a rotor 6 and a stator 4. The electric machine 5 is capable of converting electrical energy into mechanical energy in the form of rotation of the rotor 6. Moreover, the electric machine 5 may be capable of converting mechanical energy in the form of rotation of the rotor 6 into electrical energy which for example can be stored in the propulsion battery 17. In this manner the electric machine 5 may provide regenerative braking of the vehicle 3.

One of the stator 4 and the rotor 6 may comprise a number of permanent magnets and the other of the stator 4 and the rotor 6 may comprise wire windings. An alternating electric current passed through the wire windings by the power module 21′ causes a torque to be applied to the rotor 6 due to the magnetic interaction between the wire windings and the permanent magnets. During operation of the powertrain 1, the electric current passed through the wire windings is alternated in a manner following the rotation of the rotor 6. In this manner, a continuous torque can be applied to the rotor 6 during rotation thereof.

The powertrain 1 further comprises a charging module 31. The charging module 31 is connectable to an external power source 33 to charge the propulsion battery 17 using electricity from the external power source 33. The external power source may be connected to an electric power grid. The charging module 31 may comprise battery charging electronics. The charging module 31 may also be referred to as a battery charging module, a battery charger, or the like.

The powertrain 1 comprises a control unit 21. The control unit 21 is operably connected to power module 21′. The control unit 21 and the power module 21′ are together herein referred to as a control arrangement 21, 21′. In FIG. 2, the control unit 21 and the power module 21′ are illustrated as separate units. However, according to further embodiments, the control unit 21 and the power module 21′ may be combined in one unit or may be comprised in a number of separate units, wherein the number is higher than two.

According to the illustrated embodiments, the transmission 7 comprises a gearbox capable of providing different gear ratios between the rotor 6 and wheels 9 of the vehicle 3. The control arrangement 21, 21′ is operably connected to a gear selector 41 of the transmission 7 to perform gear changes of the transmission 7. According to the illustrated embodiments, the transmission 7 comprises a neutral state in which the rotor 6 of the electric machine 5 is rotationally disconnected from wheels 9 of the vehicle 3. Thus, when the transmission 7 is in the neutral state, the rotor 6 of the electric machine 5 is free to rotate even when the wheels 9 of the vehicle 3 are at stand still. According to further embodiments, the transmission 7 may comprise a fix gear ratio between the rotor 6 of the electric machine 5 and wheels 9 of the vehicle 3. Also in such embodiments, the transmission 7 may comprise a neutral state in which the rotor 6 of the electric machine 5 is rotationally disconnected from wheels 9 of the vehicle 3.

Moreover, according to the illustrated embodiments, the powertrain 1 is illustrated as comprising a coupling 43 between the transmission 7 and the wheels 9. The coupling 43 is controllable by the control arrangement 21, 21′ between an engaged state, in which the coupling 43 connects the transmission 7 to the wheels 9, and a disconnected state, in which the coupling 43 disconnects the transmission 7 from the wheels 9. The coupling 43 may comprise a dog-clutch, a friction clutch, or the like. Gears and shafts of the transmission 7 may be free to rotate when the coupling 43 is in the disengaged state also when the wheels 9 of the vehicle 3 are at stand still. The powertrain 1 may comprise one of a transmission 7 controllable to a neutral state, as explained above, or a coupling 43 as described herein. As an alternative, or in addition, the powertrain 1 may comprise another type of arrangement capable of disconnecting the rotor 6 of the electric machine 5 from wheels 9 of the vehicle 3.

According to the illustrated embodiments, the powertrain 1 comprises a lubricant circuit 13. The lubricant circuit 13 comprises a lubricant pump 15 configured to pump lubricant through the lubricant circuit 13 to lubricate portions of the powertrain 1, such as gears, shafts, and bearings of the powertrain 1. According to the illustrated embodiments, the lubricant circuit 13 is illustrated as being configured to lubricate portions of the transmission 7. However, the lubricant circuit 13 may also be configured to lubricate further portions of the powertrain 1, such as portions of the electric machine 5 and the like. The lubricant pump 15 may be driven via a shaft connected to an input shaft of the transmission 7 such that operation of the lubricant pump 15 is ensured when the input shaft of the transmission 7 is rotating. As an alternative, the lubricant pump 15 may be driven by a separate driving unit, such as a separate electric motor.

According to embodiments herein, the control arrangement 21, 21′ is configured to pass an electric current through the electric machine 5 while ensuring stand still of the vehicle 3. In this manner, heat is generated in the electric machine 5 which heats the powertrain 1 in a simple and energy-efficient manner, as is further explained herein.

The feature “ensuring stand still of the vehicle 3” means that stand still of the vehicle 3 is ensured/accomplished relative to a surface 10 on which the vehicle 3 is positioned. Thus, according to embodiments of the present disclosure, electrical current is passed through the electric machine 5 while the vehicle 3 is standing still. Stand still of the vehicle 3 can be accomplished/ensured in different ways, as is further explained herein. The surface 10 may be a surface of a parking space, a road surface, or the like. However, as understood from the herein described, in some cases, the surface 10 may be a moving surface such as a surface of a ferry capable of transporting vehicles 3. Apparently, in such cases, stand still of the vehicle 3 is ensured/accomplished relative to such a moving surface according to the embodiments herein.

According to some embodiments, the control arrangement 21, 21′ is configured to pass the electric current through the electric machine 5 in a manner ensuring stand still of the rotor 6 of the electric machine 5. The control arrangement 21, 21′ may pass the electric current through the electric machine 5 in a non-torque producing manner. As an example, the control arrangement 21, 21′ may pass the electric current in a continuous, i.e. non-alternating, manner trough wire windings of the electric machine 5. Thereby, the electric current through the electric machine 5 does not cause a torque applied to the rotor 6 and consequently no rotation of the rotor 6. As an alternative, the control arrangement 21, 21′ may pass an alternating current through a number of wire windings of the electric machine 5 while ensuring stand still of the rotor 6. In such embodiments, the frequency of the alternating current, and/or the number of wire windings through which the electric current is passed, may be selected such that no torque is applied to the rotor 6 and consequently such that stand still of the rotor 6 is ensured.

The control arrangement 21, 21′ may further ensure stand still of the rotor 6 by ensuring that the rotor 6 of the electric machine 5 is locked from rotating. The control arrangement 21, 21′ may ensure that the rotor 6 of the electric machine 5 is locked from rotating by ensuring that a transmission brake is engaged and/or by ensuring that the transmission 7 is in an engaged state, i.e. that the rotor 6 of the electric machine 5 is rotationally locked to a wheel 9 of the vehicle 3, and that at least one of a wheel brake and a transmission brake is in an engaged state. Thus, according to these embodiments, the control arrangement 21, 21′ may pass a torque producing current through the electric machine 5 while stand still of the rotor 6 of the electric machine 5 is ensured by locking rotation of the rotor 6.

According to some embodiments, the control arrangement 21, 21′ is configured to pass the electric current through the electric machine 5 to rotate the rotor 6 of the electric machine 5 while ensuring stand still of the vehicle 3 relative the surface 10 onto which the vehicle 3 is positioned. According to these embodiments, the control arrangement 21, 21′ may be configured to control the powertrain 1 to a state in which at least a portion 7′ of the transmission 7 is disconnected from the one or more wheels 9, and then rotate the portion 7′ of the transmission 7 using the rotor 6. In this manner, heat is generated in the electric machine 5 by the passing of electric current therethrough. Moreover, heat is generated in the portion 7′ of the transmission 7 as a result of frictional resistance caused by the rotation of the portion 7′ of the transmission 7.

In addition, heat may be distributed through the powertrain 1 in an improved manner by rotating the portion 7′ of the transmission 7. The portion 7′ of the transmission 7 is connected to the rotor 6 of the electric machine 5 and may be disconnected from the one or more wheels 9 by controlling the transmission 7 to a neutral state using the gear selector 41. Moreover, in embodiments in which the control arrangement 21, 21′ passes the electric current through the electric machine 5 to rotate the rotor 6, gears and shafts of the full transmission 7 may be rotationally disconnected from the wheels 9 by controlling the coupling 43 to the disengaged state. According to these embodiments, the control arrangement 21, 21′ may rotate gears and shafts of the full transmission 7 using the rotor 6 of the electric machine 5.

According to the illustrated embodiments, the lubricant pump 15 is operably connected to the portion 7′ of the transmission 7 such that the lubricant pump 15 is operating upon rotation of the portion 7′ of the transmission 7. Thus, when the portion 7′ of the transmission 7 is rotated using the rotor 6, heat is distributed through the powertrain 1 by the circulation of lubricant through the lubricant circuit 13. In these embodiments, the control arrangement 21, 21′ can be said to activate the lubricant pump 15 by rotating the portion 7′ of the transmission 7 using the rotor 6. In further embodiments, such that those where the lubricant pump 15 is driven via another type of driving unit, the control arrangement 21, 21′ may be configured to activate the lubricant pump 15 in another manner to distribute heat generated by the passing of the electric current through the electric machine 5.

According to some embodiments, the control arrangement 21, 21′ may be configured to pass an electric current through the electric machine 5 in a manner ensuring stand still of the rotor 6 and pass an electric current through the electric machine 5 to rotate the rotor 6 in time-separated steps/intervals. As an example, the control arrangement 21, 21′ may initiate a heating session by passing the electric current through the electric machine 5 in a manner ensuring stand still of the rotor 6 and then passing the electric current through the electric machine 5 to rotate the rotor 6.

According to some embodiments, the control arrangement 21, 21′ is configured to switch back and forth between a first heating mode in which the electric current is passed through the electric machine 5 in a manner ensuring stand still of the rotor 6 and a second heating mode in which the electric current is passed through the electric machine 5 to rotate the rotor 6. Thereby, when operating in the first mode, the electric machine 5 is heated in a simple and energy efficient manner and when operating in the second mode, the electric machine 5 is heated in a simple and energy efficient manner while the generated heat is efficiently distributed through the powertrain 1. The powertrain 1 may comprise a number of temperature sensors including at least one temperature sensor configured to sense a current temperature of the electric machine 5. The number of temperature sensors may also include at least one temperature sensor configured to sense a current temperature of the transmission 7. The control arrangement 21, 21′ may determine whether to operate in the first or in the second mode based on data obtained from the number of temperature sensors. The control arrangement 21, 21′ may further switch between the first and second modes based on data from the number of temperature sensors.

According to some embodiments, the control arrangement 21, 21′ is configured to input current temperature data representative of a current ambient temperature and/or a current temperature of a portion of the powertrain 1. The current temperature data may be inputted from a number of temperature sensors, such as one or more of the above mentioned type, and/or a temperature sensor configured to sense the current ambient temperature at the location of the vehicle 3. As an alternative, or in addition, the current temperature data may be inputted from another type of device, such as an external device, such as a sender sending data representative of the current ambient temperature at the location of the vehicle 3.

The control arrangement 21, 21′ may be configured to control a duration of the passing of the electric current through the electric machine 5 based on the inputted current temperature data. Thereby, the control arrangement 21, 21′ can heat the powertrain in an adaptive manner based on current temperature conditions. Thus, according to some embodiments, the control arrangement 21, 21′ is configured to control a duration of the passing of the electric current through the electric machine 5 based on data representative of a current ambient temperature. According to such embodiments, the control arrangement 21, 21′ may be configured to control a duration of the passing of the electric current such that the powertrain 1 is heated to a temperature within a wanted/determined temperature range. As an alternative, or in addition, according to some embodiments, the control arrangement 21, 21′ is configured to control a duration of the passing of the electric current through the electric machine 5 based on data representative of current temperature of a portion of the powertrain 1. According to these embodiments, as well as other embodiments described herein, the control arrangement 21, 21′ may be configured to control a duration of the passing of the electric current such that the powertrain 1 is heated to a temperature within a wanted/determined temperature range. In all these embodiments, the control arrangement 21, 21′ may control the passing of the electric current such that the temperature of the powertrain 1 is maintained within the wanted/determined temperature range once the temperature of the powertrain 1 has reached the wanted/determined temperature range.

The control arrangement 21, 21′ may be configured to control a duration of the passing of the electric current through the electric machine 5 based on the inputted current temperature data when operating in the first mode as well as when operating in the second mode. That is, the control arrangement 21, 21′ may be configured to control the duration of the passing of the electric current through the electric machine 5 in the manner ensuring stand still of the rotor 6 of the electric machine 5 based on the inputted current temperature data. As an alternative, or in addition, the control arrangement 21, 21′ may be configured to control the duration of the passing of the electric current through the electric machine 5 in the manner rotating the rotor 6 of the electric machine 5 based on the inputted current temperature data. According to embodiments herein, the duration of the passing of the electric current through the electric machine 5 may range from a number of seconds to a number of minutes.

According to some embodiments, the control arrangement 21, 21′ is configured to estimate a time at which the vehicle 3 is expected to be operated and initiate the passing of the electric current through the electric machine 5 a predetermined time before the estimated time. Thereby, the control arrangement 21, 21′ can initiate heating of the powertrain 1 a predetermined time before the vehicle 3 is expected to be operated so as to obtain a wanted/determined temperature of the powertrain 1 when operation of the vehicle is expected to be initiated. The control arrangement 21, 21′ may input and/or store data which can be used to estimate the time at which the vehicle 3 is expected to be operated. Such data may for example comprise calendar data, historic data of times the vehicle 3 has been operated, and/or driving request data, for example sent from an external device.

According to some embodiments, the control arrangement 21, 21′ is configured to input current temperature data representative of a current ambient temperature and/or a current temperature of a portion of the powertrain 1, and set a length of the predetermined time based on the current temperature data. In this manner, a wanted/determined temperature level of the powertrain 1 can be reached with higher certainty before operation of the vehicle 3 is initiated.

As is further explained herein, according to the illustrated embodiments, the control arrangement 21, 21′ is configured to heat the propulsion battery 17 using heat generated by the passing of the electric current through the electric machine 5. That is, according to the illustrated embodiments, the powertrain 1 comprises a battery coolant circuit 19. The battery coolant circuit 19 comprises a coolant pump 23 configured to pump coolant through the battery coolant circuit 19 to regulate the temperature of the propulsion battery 17. The battery coolant circuit 19 may comprise a liquid coolant such, as an aqueous coolant mixture. The battery coolant circuit 19 extends through the propulsion battery 17 such that coolant flowing through the battery coolant circuit 19 is in heat exchanging contact with the propulsion battery 17.

Moreover, according to the illustrated embodiments, the battery coolant circuit 19 extends through the power module 21′ and through the electric machine 5 such that coolant flowing through the battery coolant circuit 19 is in heat exchanging contact with the power module 21′ and with the electric machine 5. Thus, according to the illustrated embodiments, the battery coolant circuit 19 is further configured to regulate the temperature of the power module 21′ and the electric machine 5. According to some embodiments, the electric machine 5 may comprise an oil circuit configured to cool the electric machine 5, and wherein the powertrain 1 may comprise a heat exchanger configured to exchange heat between oil of the oil circuit and a liquid coolant, such as an aqueous coolant mixture of the battery coolant circuit 19. Such a heat exchanger and oil circuit are not shown in FIG. 2.

The battery coolant circuit 19 further comprises a heat exchanger 45 arranged to cool coolant flowing through the heat exchanger 45. The heat exchanger 45 may be a radiator and may be arranged at a front portion of the vehicle 3 to be subjected to a flow of air during movement of the vehicle 3. The battery coolant circuit 19 further comprises a bypass line 47 bypassing the heat exchanger 47 and a valve 49 controllable between a first state, in which the valve 49 directs coolant through the heat exchanger 45 and a second state, in which the valve 49 directs coolant through the bypass line 47.

The control arrangement 21, 21′ may be configured to heat the propulsion battery 17 using heat generated by the passing of the electric current through the electric machine 5 by activating the coolant pump 23 of the battery coolant circuit 19. In this manner, heat generated in the powertrain 1, by the passing of the electric current through the electric machine 5, is distributed to the propulsion battery 17 via the battery coolant circuit 19. Since the propulsion battery 17 is heated, the control arrangement 21, 21′ provides conditions for an improved efficiency of the propulsion battery 17 thereby providing conditions for an improved available operational range of the vehicle 3. Moreover, a more even temperature of the components of the powertrain 1 can be obtained by activating the coolant pump 23 of the battery coolant circuit 19. In connection to an activation of the coolant pump 23, the control arrangement 21, 21′ may be configured to control the valve 49 to the second state. Thereby, the coolant will flow through the bypass line 47 and waste of heat energy via the heat exchanger 45 is avoided in a heating session of the powertrain 1. According to some embodiments, the powertrain 1 comprises a separate heating circuit configured to heat the propulsion battery 17 using heat generated by the electric machine 5. According to such embodiments, the control arrangement 21, 21′ may be configured to heat the propulsion battery 17 using heat generated by the passing of the electric current through the electric machine 5 by activating a coolant pump of such a separate heating circuit.

According to the illustrated embodiments, the powertrain 1 comprises a heat exchanger 26 configured to heat an occupant compartment 25 of the vehicle 3 using heat from the powertrain 1. The occupant compartment 25 is schematically indicated in FIG. 1 and FIG. 2. In more detail, according to the illustrated embodiments, the powertrain 1 comprises an occupant compartment heating circuit 27, wherein the heat exchanger 26 is arranged in the occupant compartment heating circuit 27. The control arrangement 21, 21′ may heat the occupant compartment 25 using heat generated by the passing of the electric current through the electric machine 5 by circulating coolant through the heat exchanger 26. According to the illustrated embodiments, the occupant compartment heating circuit 27 is arranged as a coolant branch of the battery coolant circuit 19. Moreover, according to the illustrated embodiments, the occupant compartment heating circuit 27 comprises a coolant pump 29. According to these embodiments, the control arrangement 21, 21′ may heat the occupant compartment 25 using heat generated by the passing of the electric current through the electric machine 5 by activating the coolant pump 29 of the occupant compartment heating circuit 27.

According to further embodiments, the occupant compartment heating circuit 27 may be a separate circuit in heat exchanging contact with portions of the powertrain 1. Also in such embodiments, the control arrangement 21, 21′ may heat the occupant compartment 25 using heat generated by the passing of the electric current through the electric machine 5 by activating a coolant pump of such an occupant compartment heating circuit. According to still further embodiments, the occupant compartment heating circuit 27 is arranged as a coolant branch of the battery coolant circuit 19 but comprise no coolant pump 29. Instead, the coolant branch, and/or the battery coolant circuit 19, may comprise a valve controllable to regulate the flow through a heat exchanger 26 which is configured to heat the occupant compartment 25. According to such embodiments, the control arrangement 21, 21′ may heat the occupant compartment 25 using heat generated by the passing of the electric current through the electric machine 5 by activating the coolant pump 23 of the battery coolant circuit 19 and control such a valve to direct coolant through the heat exchanger 26.

According to the illustrated embodiments, the heat exchanger 26 is a radiator, wherein a fan 51 is configured to generate an airflow through the heat exchanger 26 into the occupant compartment 25 to heat the occupant compartment 25. The control arrangement 21, 21′ may be operably connected to the fan 51 and may activate the fan 51 to obtain an increased heat transfer from the powertrain 1 to the occupant compartment 25. Moreover, the control arrangement 21, 21′ may be operably connected to an air valve arrangement, also referred to as an air door arrangement, controllable between different states to direct air downstream of the heat exchanger 26 to the occupant compartment 25 and/or to the surroundings. According to such embodiments, the control arrangement 21, 21′ may control the air valve arrangement to a state in which the air downstream of the heat exchanger 26 is directed to the occupant compartment 25 in a heating session of the powertrain 1. According to further embodiments, the heat exchanger 26 may be a radiator arranged inside of the occupant compartment 25.

According to some embodiments, the control arrangement 21, 21′ is configured to perform the herein described procedure of passing the electric current through the electric machine 5 to heat the powertrain 1 only when the charging module 31 is connected to the external power source 33. The control arrangement 21, 21′ may be configured to detect when the charging module 31 is connected to the external power source 33 and may be configured to pass the electric current through the electric machine 5 to heat the powertrain 1 only when it is detected that the charging module 31 is connected to the external power source 33. Thereby, electrical energy from the external power source 33 is used to heat the powertrain 1 instead of electrical energy stored in the propulsion battery 17. In this manner, an increased available operational range of the vehicle 3 can be ensured when operation of the vehicle 3 is initiated.

According to embodiments herein, the control arrangement 21, 21′ may be configured to ensure stand still of the vehicle 3 relative to a surface 10 on which the vehicle 3 is positioned by ensuring that a wheel brake of the vehicle 3 is engaged, and/or that another type of brake or arrangement of the vehicle 3, which locks one or more wheels of the vehicle 3 from rotating, is engaged, such as a parking brake, a transmission brake, or the like.

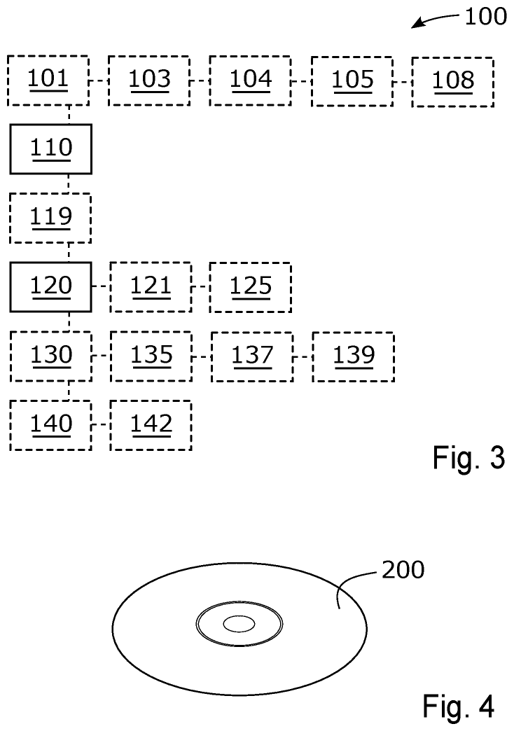

FIG. 3 illustrates a method 100 of heating a powertrain of a vehicle. The powertrain may be a powertrain 1 according to embodiments explained with reference to FIG. 2 and the vehicle may be a vehicle 3 explained with reference to FIG. 1. Therefore, below, simultaneous reference is made to FIG. 1-FIG. 3. The method 100 is a method 100 of heating a powertrain 1 of a vehicle 3, wherein the powertrain 1 comprises an electric machine 5 configured to provide motive power to the vehicle 3. The method 100 comprises the step of:
passing 110, 120 an electric current through the electric machine 5 while ensuring stand still of the vehicle 3 relative to a surface 10 on which the vehicle 3 is positioned.

According to some embodiments, the step of passing 110 the electric current through the electric machine 5 comprises the step of:
passing 110 the electric current through the electric machine 5 in a manner ensuring stand still of a rotor 6 of the electric machine 5.

According to some embodiments, the step of passing 120 the electric current through the electric machine 5 comprises the step of:
passing 120 the electric current through the electric machine 5 to rotate a rotor 6 of the electric machine 5.

According to some embodiments, the powertrain 1 comprises a transmission 7 configured to transmit power between the electric machine 5 and one or more wheels 9 of the vehicle 3, and wherein the method 100 comprises the step of:
controlling 119 the powertrain 1 to a state in which at least a portion 7′ of the transmission 7 is disconnected from the one or more wheels 9, and
rotating 121 the portion 7′ of the transmission 7 using the rotor 6.

According to some embodiments, the step of passing 110, 120 an electric current through the electric machine 5 comprises the time-separated steps of:
passing 110 an electric current through the electric machine 5 in a manner ensuring stand still of the rotor 6, and
passing 120 an electric current through the electric machine 5 to rotate the rotor 6.

According to some embodiments, the step of passing 110 the electric current through the electric machine 5 in a manner ensuring stand still of the rotor 6 is performed prior to the step of passing 120 the electric current through the electric machine 5 to rotate the rotor 6.

According to some embodiments, the method 100 comprises the step of:
switching 125 back and forth between a first heating mode in which the electric current is passed through the electric machine 5 in a manner ensuring stand still of the rotor 6 and a second heating mode in which the electric current is passed through the electric machine 5 to rotate the rotor 6.

According to some embodiments, the method 100 comprises the steps of:
inputting 105 current temperature data representative of a current ambient temperature and/or a current temperature of a portion of the powertrain 1, and
controlling 130 a duration of the passing of the electric current through the electric machine 5 based on the inputted current temperature data.

According to some embodiments, the method 100 comprises the steps of:
estimating 101 a time at which the vehicle 3 is expected to be operated, and
initiating 108 the step of passing 110, 120 the electric current through the electric machine 5 a predetermined time before the estimated time.

According to some embodiments, the method 100 comprises the steps of:
inputting 103 current temperature data representative of a current ambient temperature and/or a current temperature of a portion of the powertrain 1, and
setting 104 a length of the predetermined time based on the current temperature data.

According to some embodiments, the powertrain 1 comprises a lubricant circuit 13 comprising a lubricant pump 15 configured to pump lubricant through the lubricant circuit 13 to lubricate portions of the powertrain 1, and wherein the method 100 comprises the step of:
activating 135 the lubricant pump 15.

According to some embodiments, the powertrain 1 comprises a propulsion battery 17, and wherein the method 100 comprises the step of:
heating 137 the propulsion battery 17 using heat generated by the passing of the electric current through the electric machine 5.

According to some embodiments, the powertrain 1 comprises a battery coolant circuit 19 comprising a coolant pump 23 configured to pump coolant through the battery coolant circuit 19 to regulate the temperature of the propulsion battery 17, and wherein the step of heating 137 the propulsion battery 17 comprises the step of:
activating 139 the coolant pump 23 of the battery coolant circuit 19.

According to some embodiments, the vehicle 3 comprises an occupant compartment 25, and wherein the method 100 comprises the step of:
heating 140 the occupant compartment 25 using heat generated by the passing of the electric current through the electric machine 5.

According to some embodiments, the powertrain 1 comprises a heat exchanger 26 configured to heat the occupant compartment 25 using heat from the powertrain 1, and wherein the step of heating 140 the occupant compartment 25 comprises the step of:
circulating 142 coolant through the heat exchanger 26.

According to some embodiments, the vehicle 3 comprises a propulsion battery 17 and a charging module 31 connectable to an external power source 33 to charge the propulsion battery 17 using electricity from the external power source 33, and wherein the step/steps of passing 110, 120 the electric current through the electric machine 5 is/are performed when the charging module 31 is connected to the external power source 33. According to some embodiments, the step/steps of passing 110, 120 the electric current through the electric machine 5 is/are performed only when the charging module 31 is connected to the external power source 33.

According to some embodiments, the method 100 comprises the step of:
locking rotation of one or more wheels 9 of the vehicle 3 to ensure stand still of the vehicle 3 relative to a surface 10 on which the vehicle 3 is positioned.

According to some embodiments, the step of locking rotation of one or more wheels 9 of the vehicle 3 comprises at least one of the steps:
controlling a wheel brake of the vehicle 3 to an engaged state, and
controlling another type of brake or arrangement of the vehicle 3 to an engaged state to lock one or more wheels 9 from rotating.

It will be appreciated that the various embodiments described for the method 100 are all combinable with the control arrangement 21, 21′ as described herein. That is, the control arrangement 21, 21′ may be configured to perform any one of the method steps 101, 103, 104, 105, 108, 110, 119, 120, 121, 125, 130, 135, 137, 139, 140, and 142 of the method 100.

FIG. 4 illustrates computer-readable medium 200 comprising instructions which, when executed by a computer, cause the computer to carry out the method 100 according to some embodiments.

According to some embodiments, the computer-readable medium 200 comprises a computer program comprising instructions which, when the program is executed by a computer, cause the computer to carry out the method 100 according to some embodiments.

The control arrangement 21, 21′ may be connected to one or more components of the powertrain 1, and/or one or more components of the vehicle 3, in order to perform the method 100 illustrated in FIG. 3. According to some embodiments, control arrangement 21, 21′ comprises a control unit 21 and a power module 21′. The control unit 21 may be operably connected to power module 21′. The control unit 21 may control/cause the power module 21′ to pass the electric current through the electric machine 5 while ensuring stand still of the vehicle 3 so as to heat the powertrain 1.

One skilled in the art will appreciate that the method 100 of heating a powertrain 1 of a vehicle 3 may be implemented by programmed instructions. These programmed instructions are typically constituted by a computer program, which, when it is executed in the control arrangement 21, 21′, ensures that the control arrangement 21, 21′ carries out the desired control, such as the method steps 101, 103, 104, 105, 108, 110, 119, 120, 121, 125, 130, 135, 137, 139, 140, and 142 described herein. The computer program is usually part of a computer program product 200 which comprises a suitable digital storage medium on which the computer program is stored.

The control arrangement 21, 21′ may comprise a calculation unit which may take the form of substantially any suitable type of processor circuit or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21, 21′ may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 21, 21′ is connected to components of the powertrain 1 and/or the vehicle 3 for receiving and/or sending input and output signals. These input and output signals may comprise waveforms, pulses or other attributes which the input signal receiving devices can detect as information and which can be converted to signals processable by the control arrangement 21, 21′. These signals may then be supplied to the calculation unit. One or more output signal sending devices may be arranged to convert calculation results from the calculation unit to output signals for conveying to other parts of the vehicle's control system and/or the component or components for which the signals are intended. Each of the connections to the respective components of the powertrain 1 and/or the vehicle 3 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the powertrain 1 comprises a control arrangement 21, 21′ but might alternatively be implemented wholly or partly in two or more control arrangements or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles of the type here concerned are therefore often provided with significantly more control arrangements than depicted in FIG. 2, as one skilled in the art will surely appreciate.

The computer program product 200 may be provided for instance in the form of a data carrier carrying computer program code for performing at least some of the method steps 101, 103, 104, 105, 108, 110, 119, 120, 121, 125, 130, 135, 137, 139, 140, and 142 according to some embodiments when being loaded into one or more calculation units of the control arrangement 21, 21′. The data carrier may be, e.g. a CD ROM disc, as is illustrated in FIG. 4, or a ROM (read-only memory), a PROM (programmable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21, 21′ remotely, e.g., over an Internet or an intranet connection, or via other wired or wireless communication systems.

As understood from the herein described, the electrical current is passed through the electric machine 5 while the vehicle 3 is standing still relative to a surface 10 on which the vehicle 3 is positioned. Accordingly, the step/steps of passing 110, 120 an electric current through the electric machine 5 is/are performed while the vehicle 3 is standing still relative to a surface 10 on which the vehicle 3 is positioned. Therefore, throughout this disclosure, the wording “while ensuring stand still of the vehicle 3” may be replaced with the wording “while the vehicle 3 is standing still” or with the wording “while the vehicle 3 is standing still relative to a surface 10 on which the vehicle 3 is positioned”.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of heating a powertrain of a vehicle, wherein the powertrain comprises an electric machine configured to provide motive power to the vehicle, and wherein the method comprises the step of:
passing an electric current through the electric machine to rotate a rotor of the electric machine while ensuring stand still of the vehicle.

2. The method according to claim 1, wherein the powertrain comprises a transmission configured to transmit power between the electric machine and one or more wheels of the vehicle, and wherein the method further comprises the steps of:
controlling the powertrain to a state in which at least a portion of the transmission is disconnected from the one or more wheels; and
rotating the portion of the transmission using the rotor.

3. The method according to claim 1, further comprising the separate step of:
passing an electric current through the electric machine in a manner ensuring stand still of the rotor.

4. The method according to claim 3, wherein the step of passing the electric current through the electric machine in a manner ensuring stand still of the rotor is performed prior to the step of passing the electric current through the electric machine to rotate the rotor.

5. The method according to claim 3, or wherein the method comprises the step of:
switching back and forth between a first heating mode in which the electric current is passed through the electric machine in a manner ensuring stand still of the rotor and a second heating mode in which the electric current is passed through the electric machine to rotate the rotor.

6. The method according to claim 1, wherein the method further comprises the steps of:
inputting current temperature data representative of a current ambient temperature and/or a current temperature of a portion of the powertrain; and
controlling a duration of the passing of the electric current through the electric machine based on the inputted current temperature data.

7. The method according to claim 1, wherein the powertrain comprises a propulsion battery, and wherein the method further comprises the step of:
heating the propulsion battery using heat generated by the passing of the electric current through the electric machine.

8. The method according to claim 1, wherein the vehicle comprises an occupant compartment, and wherein the method further comprises the step of:
heating the occupant compartment using heat generated by the passing of the electric current through the electric machine.

9. A computer program comprising computer program code stored on a non-transitory computer-readable medium, said computer program product used for heating a powertrain of a vehicle, wherein the powertrain comprises an electric machine configured to provide motive power to the vehicle, said computer program code comprising computer instructions to cause one or more control units to perform the following operation:
passing an electric current through the electric machine to rotate a rotor of the electric machine while ensuring stand still of the vehicle.

10. (canceled)

11. A control arrangement for a powertrain of a vehicle, wherein the powertrain comprises an electric machine configured to provide motive power to the vehicle, and wherein the control arrangement is configured to:
pass an electric current through the electric machine to rotate a rotor of the electric machine while ensuring stand still of the vehicle.

12. A powertrain for a vehicle, wherein the powertrain comprises:
an electric machine configured to provide motive power to the vehicle; and
a control arrangement configured to pass an electric current through the electric machine to rotate a rotor of the electric machine while ensuring stand still of the vehicle.

13. A vehicle comprising a powertrain comprising
an electric machine configured to provide motive power to the vehicle; and
a control arrangement configured to pass an electric current through the electric machine to rotate a rotor of the electric machine while ensuring stand still of the vehicle.

14. The control arrangement according to claim 11, wherein the powertrain comprises a transmission configured to transmit power between the electric machine and one or more wheels of the vehicle, and wherein the control arranged is further configured to:
control the powertrain to a state in which at least a portion of the transmission is disconnected from the one or more wheels; and
rotate the portion of the transmission using the rotor.

15. The control arrangement according to claim 11, wherein the control arranged is further configured to:
pass an electric current through the electric machine in a manner ensuring stand still of the rotor.

16. The control arrangement according to claim 15, wherein the passing of electric current through the electric machine in a manner ensuring stand still of the rotor is performed prior to the passing the electric current through the electric machine to rotate the rotor.

17. The control arrangement according to claim 15, wherein the control arranged is further configured to:
switch back and forth between a first heating mode in which the electric current is passed through the electric machine in a manner ensuring stand still of the rotor and a second heating mode in which the electric current is passed through the electric machine to rotate the rotor.

18. The control arrangement according to claim 11, wherein the control arranged is further configured to:
input current temperature data representative of a current ambient temperature and/or a current temperature of a portion of the powertrain; and
control a duration of the passing of the electric current through the electric machine based on the inputted current temperature data.

19. The control arrangement according to claim 11, wherein the powertrain comprises a propulsion battery, and wherein the control arranged is further configured to:
heat the propulsion battery using heat generated by the passing of the electric current through the electric machine.

20. The control arrangement according to claim 11, wherein the vehicle comprises an occupant compartment, and wherein the control arranged is further configured to:
heat the occupant compartment using heat generated by the passing of the electric current through the electric machine.
